(19) United States
(12) Patent Application Publication
(10) Pub. No.: US 2015/0298227 A1
(43) Pub. Date: Oct. 22, 2015

(54) Fracture-Splitting Apparatus and Fracture-Splitting Method for Fracture-Splitting Workpieces

(71) Applicant: Alfing Kessler Sondermaschinen GmbH, Aalen (DE)

(72) Inventor: Ralf Mullner, Ostfildern (DE)

(21) Appl. No.: 14/418,519

(22) PCT Filed: Jul. 4, 2013
(86) PCT No.: PCT/EP2013/001963

§ 371 Date: Jan. 30, 2015

(30) Foreign Application Priority Data
Aug. 2, 2012 (DE) 10 2012 015 385.6

(51) Int. Cl. B23D 31/00

(52) U.S. Cl. CPC B23D 31/003

(57) ABSTRACT

A fracture-splitting method and a fracture-splitting apparatus for fracture-splitting workpieces having a cooling device for cooling the workpiece in a splitting zone, and having a fracturing device for fracture-splitting the workpiece in the region of the cooled splitting zone, wherein an inflow coolant duct opens out at at least one outlet opening of the cooling device in order to cool the splitting zone, wherein the cooling device has at least one sealing portion for bearing in a sealing manner against the workpiece next to the splitting zone in order to cool the workpiece in the splitting zone in a locally delimited manner, and/or has at least one admission opening of at least one outflow coolant duct, said admission opening being arranged next to the at least one outlet opening of the inflow coolant duct, in order to conduct the coolant away from the splitting zone of the workpiece.

The invention relates to a fracture-splitting apparatus for the fracture-splitting of workpieces, in particular engine components or connecting rods, together with a corresponding fracture-splitting method.

It is a known technology to separate engine components, for example connecting rods, in the context of a so-called cracking or fracturing process, so that the components thus separated, for example a connecting rod cover and a connecting rod big end, may then be rejoined. So that the fracture-splitting process runs in a controlled manner it is customary to make one or more notches in the relevant workpiece, for example using a laser, as described e.g. in DE 10 2007 053 814 A1.

DE 10 2008 063 731 A1 discloses a method and an apparatus for fracture-splitting, in which a fracture-splitting zone is cooled before fracture-splitting using a cooling mandrel with spreader jaws which may be cooled.

It has however been found in practice that the workpieces to be machined do not in every case fracture faultlessly, since the material to be fractured also has a certain toughness.

It is therefore the problem of the present invention to suggest an improved fracture-splitting apparatus and an improved fracture-splitting method.

The problem is solved by providing a fracture-splitting apparatus for the fracture-splitting of workpieces, in particular engine components or connecting rods, which has a cooling unit for cooling the workpiece in a splitting zone and a fracturing device for fracture-splitting of the workpiece in the area of the cooled splitting zone, wherein an inflow coolant passage opens out at one or more outlet openings of the cooling unit to cool the splitting zone, wherein the cooling unit has for locally limited cooling of the workpiece in the splitting zone at least one sealing section for sealing contact with the workpiece adjacent to the splitting zone and/or to remove the coolant from the splitting zone of the workpiece at least one inlet opening of at least one outflow coolant passage arranged next to the outlet opening or openings of the inflow coolant passage.

To solve the problem, there is also provided a fracture-splitting method for the fracture-splitting of workpieces, in particular engine components or connecting rods, with the steps:
cooling of a splitting zone of the workpiece by a cooling unit, comprising
application of the coolant to the splitting zone via an inflow coolant passage which opens out at one or more outlet openings of the cooling unit to cool the splitting zone
locally limited cooling of the workpiece in the splitting zone through sealing application of at least one sealing section of the cooling unit on the workpiece next to the splitting zone and/or removal of the coolant from the splitting zone of the workpiece via at least one outflow coolant passage, wherein the outflow coolant passage or passages has or have at least one inlet opening adjacent to the outlet opening or openings of the inflow coolant passage, and
fracture-splitting of the workpiece in the area of the cooled splitting zone.

Here it is a basic concept of the invention that the workpiece to be machined, for example a connecting rod, an engine block or the like, is cooled down locally and therefore in a targeted manner, so that the material is as it were locally embrittled and therefore fractures more easily. As compared with cooling down of the whole workpiece, much less energy is required. Moreover, a workpiece which has been completely cooled down is, after fracture-splitting, very difficult to process further, for example because the workpiece cools intensely the contact points of the handling and machining systems to be used subsequently. It may then be necessary to undertake localised reheating of individual machine components, specifically the aforementioned contact points.

Intensely cooled workpiece surfaces also tend to ice up, which may also lead for example to corrosion of the workpiece. Further processing, for example machining, of the workpiece is also made more difficult if the workpiece is very cold. It is therefore advantageous that the workpiece, cooled only locally and therefore embrittled, is easily fractured or fracture-split, but may then be reheated with no great cost, thereby greatly facilitating handling and further processing of the workpiece,

A particular field of application of the invention is the machining of connecting rods. But also engine blocks, rods and other similar components may be machined more easily according to the invention, and in particular are more easily processed after fracture-splitting.

The workpiece may be fractured easily in the cooled splitting zone, which for example also reduces the force required for the fracturing device or the fracturing tool, and also conserves the tool.

The sealing section and/or the outlet opening or openings and/or the inlet opening or openings are provided preferably on a cooling passage body of the cooling unit. Running expediently in the cooling passage body or bodies is at least one section of the inflow coolant passage or passages and/or a section of the outflow coolant passage or passages. The cooling passage body may for example be inserted in or may close an opening of the workpiece. The cooling passage body may also be provided to cover a surface section of the workpiece.

The cooling passage body or bodies comprises or comprise for example one or more tubular bodies, lances or the like. The cooling passage body may however also be plate-shaped, so that the cooling passage body is especially suitable for covering a surface of the workpiece. It goes without saying that the cooling unit also includes several cooling passage bodies, for example tubular bodies, cover bodies, plate bodies or the like.

It is of advantage when a seal assembly, for example an elastic seal, an O-ring or the like, is provided on the sealing section. This enhances the sealing effect.

It is also possible, though, for a body of the cooling unit, for example a tube, to have the sealing section, wherein the aforementioned seal assembly represents only one option. The sealing section, for example a peripheral wall of the tube, may fit up directly against the workpiece to be machined, for example a wall of a connecting rod, thereby preventing the coolant from escaping from the area of the splitting zone.

The cooling unit is preferably designed to apply the coolant under pressure to the splitting zone of the workpiece. This prevents or at least reduces blistering or the formation of vapour bubbles which would otherwise result due to the temperature difference between the coolant or cooling medium on the one hand and the workpiece surface or the splitting zone on the other. The method, advantageously further developed, provides for the coolant to be applied under pressure to the splitting zone of the workpiece.

At this point it may be noted that the application of the coolant under pressure to the workpiece may be effected and has turned out to be advantageous not only locally, i.e. in the area of the splitting zone, but also that this represents an independent invention, namely cooling a workpiece under pressure, including the workpiece as a whole. It lies e.g. within the framework of this variant or independent invention, that the workpiece as a whole is pressurised by the coolant in a pressure chamber. No or only a few blisters then form on the workpiece as a whole.

By way of example, the sealing section of the cooling unit is suitably designed or the seal assembly is suitably pressure-tight so that application of the coolant under pressure to the splitting zone of the workpiece is facilitated. Preferably, in addition, a coolant generator is provided. It is also advantageous if, precisely for application of the coolant under pressure, the cooling unit may be pressurised by a suitable contact pressure by which the cooling unit with its sealing section or with the seal assembly then fits up against the workpiece or the splitting zone of the workpiece.

Preferably the cooling unit is designed to apply the coolant to the splitting zone in a liquid state. The fracture-splitting method is also advantageously designed for application of the coolant to the splitting zone in a liquid state.

The liquid coolant, for example liquid oxygen, nitrogen or the like, has a better heat or cold transfer with respect to the workpiece surface. In this connection it is in turn advantageous for the coolant to be under pressure, so that blistering is avoided. The heat or cold transfer is namely much better from the liquid to the solid phase than from the gaseous to the solid phase. Consequently the liquid coolant cools the workpiece in the splitting zone significantly better than a gaseous coolant for example present in bubbles.

Preferably the fracture-splitting apparatus has a regeneration unit for the regeneration or cooling of the coolant returning via the outflow coolant passage and for feeding to the inflow coolant passage the coolant thus cooled down.

A further measure, especially advantageous in this configuration, provides for the outflow coolant passage and the inflow coolant passage to form parts of a self-contained coolant circuit.

Naturally, if applicable, several outflow coolant passages and/or inflow coolant passages are connected to the self-contained coolant circuit or form a self-contained coolant circuit and/or are connected to the regeneration unit.

Both of the measures referred to above contribute to the loss of as little energy as possible, and also to the provision at low cost of a fresh cooled coolant for cooling of the workpiece, in particular locally, in the area of the splitting zone.

The cooling unit expediently has a tubular body which may be inserted in an opening of the workpiece. The tubular body is for example in the form of a lance. Naturally, the tubular body may have different cross-sectional or peripheral contours, for example a round peripheral contour, but also one which is polygonal. The tubular body or the lance may therefore for example be inserted in a drilled hole in a connecting rod and there, as it were, bring about from the inside the cooling effect according to the invention.

The outlet opening or openings and/or the inlet opening or orifices are expediently provided on a peripheral wall of the tubular body. Accordingly, the coolant may for example flow radially outwards from the tubular body or the lance.

The outer periphery and/or one end face of the tubular body are expediently provided with a seal assembly and/or form the sealing section or sections, but at least a portion thereof. Consequently, therefore, the outer periphery of the tubular body may for example make internal contact with the drilled hole or the opening, and there deploy the sealing effect.

A line with the inflow coolant passage is expediently provided in an interior of a line with the outflow coolant passage. The coolant is therefore able to flow towards the workpiece, as it were in the interior of the outflow coolant passage. This arrangement is extremely compact.

The sealing section, for example a seal assembly fitted to it, a surface of the cooling unit or a body of the cooling unit, expediently encompasses an operating area of the cooling unit at which the outlet opening or openings and/or the inlet opening or orifices are located. Between the cooling unit and the workpiece, by means of the sealing section, for example the seal assembly, a coolant chamber is formed, when the cooling unit is in contact with the workpiece. The coolant is therefore used very efficiently.

Expediently the cooling unit has an insertion hole for insertion or pushing through the workpiece. The inflow coolant passage and/or the outflow coolant passage—or several thereof in each case—communicate with the insertion hole for introducing the coolant into the insertion hole or removing the coolant from the insertion hole. The coolant thus flows for example directly into the insertion hole and thereby comes into cooling contact with the workpiece.

Preferably at least one sealing device is provided for closing an opening of the workpiece adjacent to the splitting zone. For example the opening is a drilled hole into which the cooling unit dips.

Preferably the sealing device includes a sealing element, separate from the cooling unit, for example a cover, a plug or similar. The sealing element is expediently movable independently of the cooling unit, at any rate from its component which has the outlet opening or the inlet opening, so that for example this component and/or the sealing element may be guided to or from the workpiece independently of one another.

The sealing device includes expediently a first sealing element and a second sealing element for sealing a first opening and a second opening of a through passage of the workpiece. By way of example, the two sealing elements are guided towards the respective first and second openings from opposite sides of the workpiece, and seal these openings.

The sealing device includes expediently the outlet opening or openings and the inlet opening or openings. Preferably the sealing device forms a component part of the cooling unit. As mentioned, it is possible that for example one sealing element of the sealing device has a coolant passage, while the other sealing element or other sealing elements are as it were passive, i.e. have no coolant passage or opening communicating with a coolant passage.

The outlet opening or openings is expediently located between two inlet openings. Therefore, for example, the coolant flowing out of the outlet opening is able to flow along the workpiece and is then led away from the workpiece through the two adjacent inlet openings. Expediently provided between the outlet opening and the adjacent inlet openings are channels or slots in which the coolant may flow from one opening to the other.

Expediently it is also provided that the inlet opening or openings extend in annular form around the outlet opening or openings. For example the inlet opening is arranged within a ring or annulus of outlet openings.

The coolant expediently comprises alcohol or nitrogen, in particular liquid nitrogen. It is preferable for the coolant to be non-oxidising.

Cooling is effected expediently in a range of, for example, 30-80 Kelvin, preferably 20 to 50 K. Also, cooling by 10 K to 30 K or also only by around 20 K is advantageous.

Cooling is expediently a type of shock cooling, i.e. the workpiece is cooled adequately in the splitting zone for example within 1 to 2 seconds, perhaps also 3 to 4 seconds.

Preferably the fracture-splitting apparatus forms part of a larger unit, which for example also includes a notching device for making notches in the workpiece, for example using a laser. The fracture-splitting apparatus may be or form a station in such a larger unit.

Preferably there is a drive assembly for relative adjustment of the workpiece and the cooling unit, in particular the cooling passage body or bodies, towards or away from one another, e.g. an electrical and/or fluidic positioning drive for driving the cooling passage body or bodies. For the sealing element or elements too, a drive is advantageous. With the drive assembly, operator intervention is not necessary or is at least made easier.

Embodiments of the invention are explained below with the aid of the drawing, which shows in:

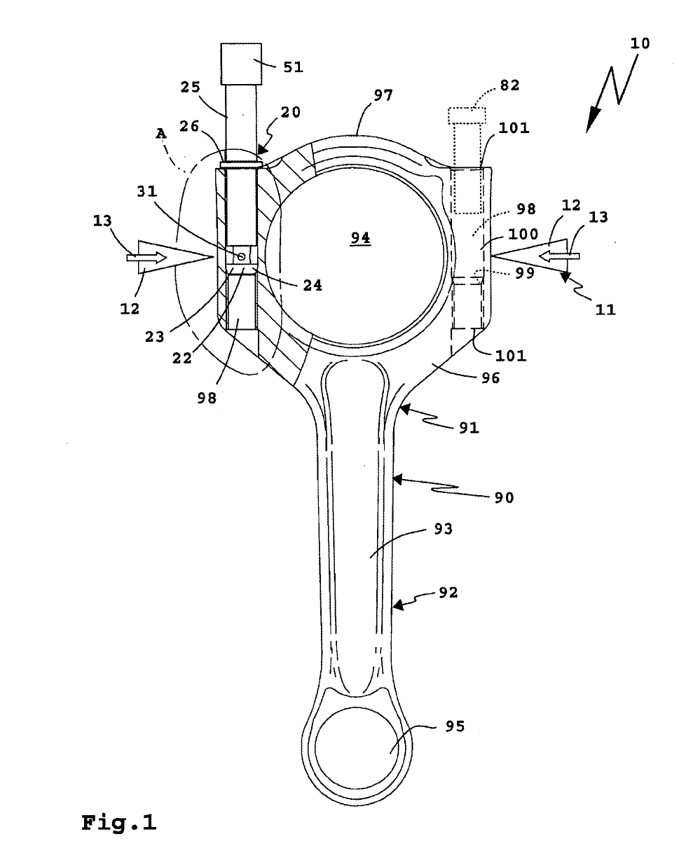

FIG. 1 a workpiece to be machined with a schematically depicted fracture-splitting apparatus which has a cooling unit

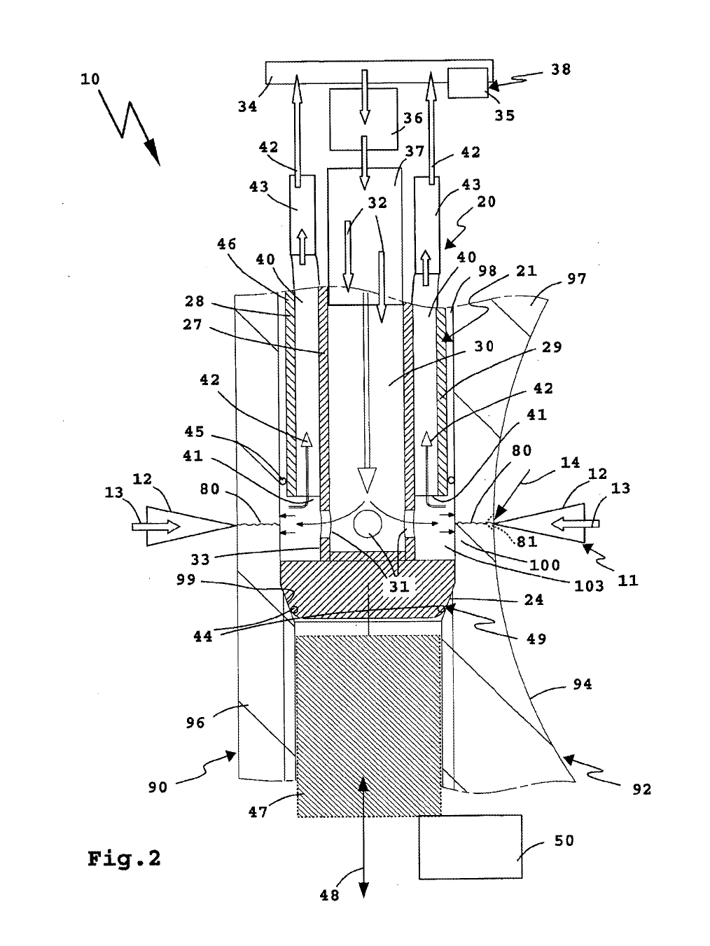

FIG. 2 a detail A of FIG. 1 with a front section of the cooling unit, together with supply lines of the cooling unit

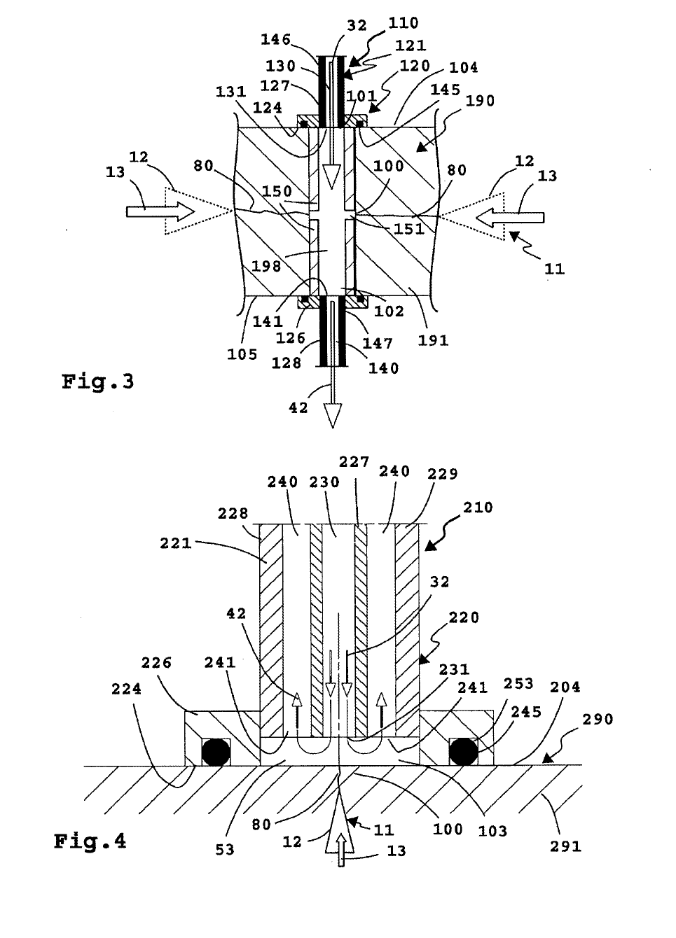

FIG. 3 a cross-sectional view of a second fracture-splitting apparatus with an alternative cooling unit

FIG. 4 a cross-sectional view of a third fracture-splitting apparatus, showing only a front section of its cooling unit

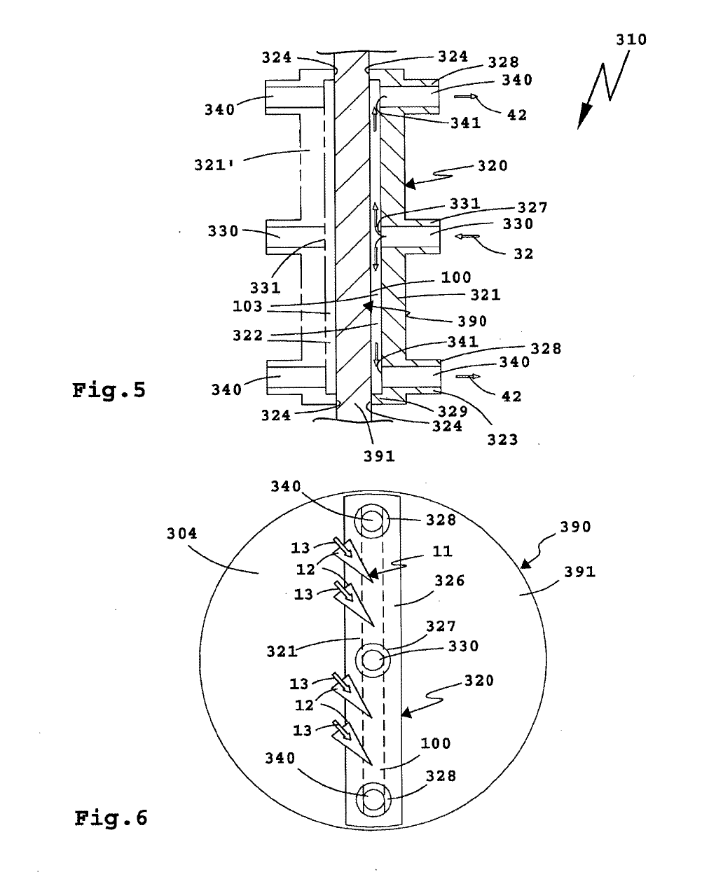

FIG. 5 a cross-sectional view of a fourth fracture-splitting apparatus, showing only a front section of its cooling unit

FIG. 6 a top view of the arrangement according to FIG. 5, including a workpiece to be split

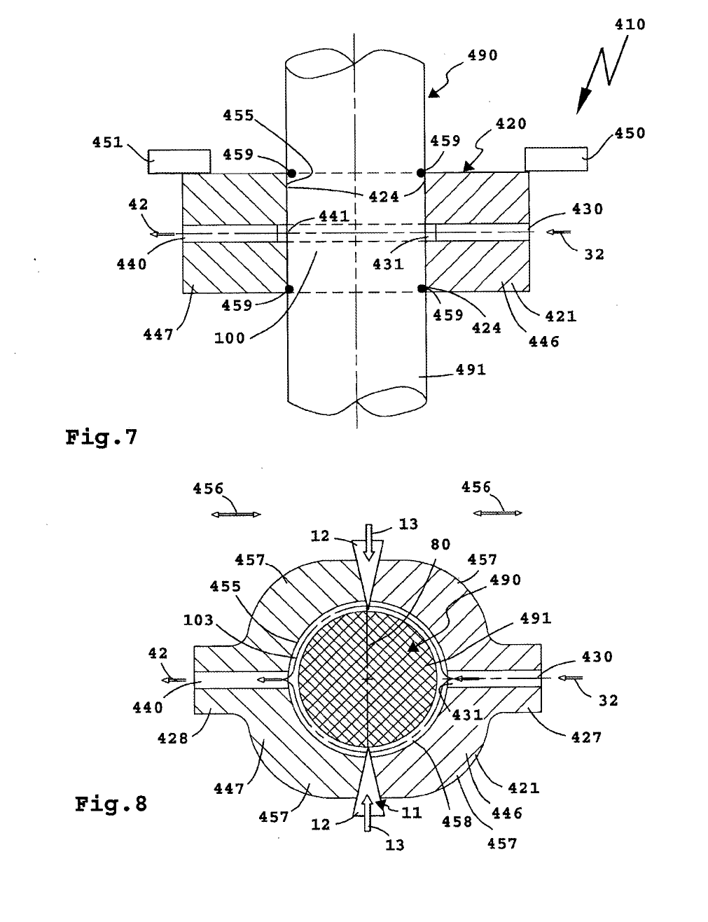

FIG. 7 a side cross-sectional view of a fifth fracture-splitting apparatus, showing only a front section of its cooling unit, and

FIG. 8 a horizontal section through the arrangement according to FIG. 7.

A fracture-splitting apparatus 10 shown in FIG. 1, together with further fracture-splitting apparatus units 110, 210, 310 and 410 shown in FIGS. 3-8 have in part identical or similar components, which are provided with the same reference numbers. If the components vary, reference numbers differing by 100 in each case are used.

The fracture-splitting apparatus 10 is used for the machining of a workpiece 90, for example an engine component 91. Shown as the workpiece 90 is a connecting rod 92. The connecting rod 92 has a connecting rod shank 93, at the long ends of which are provided a large ring 94 and a small ring 95. In the area of the large ring 94 a connecting rod cover 97 is to be separated from a connecting rod big end 96. A corresponding fracture line 80 is plotted in FIG. 2. A drilled hole 98, into which a screw 82 (schematic in FIG. 1) may be screwed, passes at the side through the connecting rod cover 97 and the connecting rod big end 96, to fasten the connecting rod cover 97 to the connecting rod big end 96.

The fracture-splitting apparatus 10 has by way of example a notching device 14 to make the notches 81, for example a laser unit. Also provided is a fracturing device 11, of which two fracture-splitting workpieces 12, for example fracturing wedges, are shown. The fracture-splitting workpieces 12 are guided for example along an arrow direction 13 to the workpiece 90, to press into the notches 81 and so split the workpiece 90 along the fracture line 80 or the fracture-splitting line. To make this split precisely and/or to minimise the force required to operate the fracture-splitting workpieces 12, even if for example the workpieces 90 are relatively tough and split only poorly, the following measures are provided:

A cooling unit 20 serves for localised cooling of the workpiece 90 in the area of a splitting zone 100. The splitting zone 100 is provided for example next to a drilled hole 98, somewhat above a step 99 inside the drilled hole 98. There the fracture-splitting workpieces 12 are set in place from the outside or the inside.

The cooling unit 20 includes a cooling passage body 21 in the form of a lance or a tubular body. The cooling passage body 21 may be inserted by its free end 22 into the drilled hole 98. A head 23 of the cooling passage body 21 is then positioned with sealing, by a radial outer periphery representing a sealing section 24, at the step 99. By way of example the head 23, in the area of the sealing section 24, is conically inclined, so that its outer contour may lie flat against the conical inclined step 99, and thus deploy its sealing effect.

Further sealing may be provided by a sealing flange 26 on a shank 25 of the cooling passage body 21, which fits up with sealing against an upper end face or an edge of an opening 101 of the drilled hole 98. Thus, as it were, a chamber is formed between the sealing section 24 and the upper sealing flange 26.

In the cooling passage body 21 runs a tube 27 with an inflow coolant passage 30 for a coolant 32, for example liquid nitrogen. The inflow coolant passage 30 opens out in the area of the head 23 at several, for example 3 or 4, outlet openings 31. The outlet openings 31 are for example provided on the apparatus of the tube 27. Consequently the coolant 32 forming as it were an inflow coolant is able to flow out of the cooling passage body 21 and arrive at the inner wall of the drilled hole 98, so as to markedly cool the latter, for example by 10-30 K, namely in the area of the splitting zone 100.

The outflowing coolant 32 is however as it were recaptured, since it flows into inflow openings 41 of an outflow coolant passage 40. The outflow coolant passage 40 is provided in a tube 28.

The tube 27 is located in the interior of the tube 28. Accordingly, the inflow coolant 32 flows as it were within the tube 27 towards the head 23 or end 22 of the cooling passage body 21, exiting there from the outlet openings 31 in order to cool the workpiece 90 locally, namely in the area of the splitting zone 100, and is quasi-directly recaptured, namely by the inlet opening 41.

The tube 27 is mounted concentrically in the tube 28. The tube 27 protrudes from the tube 28, with the outlet openings 31 being provided in the protruding section 33. The inlet opening 41 runs in a ring around the inflow coolant passage 30 and the tube 27 respectively. The tube 28 is in fact open at the end, so that a space between its peripheral wall 29 and the tube 27 bounds the inlet opening 41.

The other components of the cooling unit 20 are indicated only schematically, so for example a flexible line 37 through which the inflow coolant 32 is fed into the inflow coolant passage 30. The line 37 communicates for example with a reservoir 34 for provision of the coolant 32. The outflow coolant passage 40 is likewise connected to the reservoir 34 via a line 43, so that outflow coolant 42 flowing back through the outflow coolant passage 40 is fed back into the reservoir 34.

Provided at the reservoir 34 is for example a cooling unit 35 for cooling the outflow coolant 42, i.e. as it were to regenerate the coolant 42 into a cooled-down inflow coolant 32. The cooling unit 35 thus forms e.g. an integral part of the regeneration unit 38.

Expediently provided is a pump 36, by which the coolant 32 may be pressurised so that it flows out of the outlet openings 31 with pressure and thus remains in the liquid state when it makes cooling contact with the workpiece 90 and the inner wall of the drilled hole 98 in the area of the splitting zone 100 respectively.

The coolant 32 remains under pressure even when it flows out of the outlet openings 31. The sealing flange 26 namely closes the drilled hole 98 or the upper opening 101 of the drilled hole 98. The cooling passage body 21 therefore as it were bounds a cooling chamber or coolant chamber 103 in the interior of the drilled hole 98.

Naturally, additional sealing measures may also be provided, such as for example a ring seal, not illustrated, at the lower underside of the sealing flange 26 facing the opening 101. In addition, of course, seals may be provided at other points, for example a seal 44 on the outer periphery of the sealing section 24, or an optional seal 45 provided on the peripheral wall 29. The seals 44 and 45 are e.g. components of a seal assembly 49.

The cooling passage body 21 forms as it were a sealing element 46 for sealing the upper opening 101 and, since it fits up with the sealing section 24 against the step 99, it is at the same time a lower sealing element. As an alternative or additional measure it is advantageous to provide a further sealing element 47, movable separately from the cooling passage body 21, to seal the lower opening 101 of the drilled hole 98. For example, as indicated by an arrow 48, the sealing element 47 which is designed e.g. as a type of plug, may be inserted from below into the drilled hole 98, thereby sealing the latter from below.

The relevant drives 50, 51, positioning elements or the like, by which the cooling unit 20 may be inserted from above into the drilled hole 98 and/or the sealing element 47 may be inserted from below into the drilled hole 98, are shown schematically in the drawing and are in any case obvious to the person skilled in the art.

It goes without saying that a suitable handling device, for example a robot or other handling device, also for example the workpiece to be machined, for example the connecting rod 92, may provide guidance at the cooling unit 20 so that the latter remains stationary, i.e. the workpiece is moved relative to the cooling unit.

With a cooling unit 120 shown in FIG. 3, a fracture-splitting apparatus 110 may machine, in a manner according to the invention, a workpiece 190 which has or is formed by a plate 191.

A cooling passage body 121 of the cooling unit 120 has a tube section 127 in which runs an inflow coolant passage 130 to supply an inflow coolant 32. Provided on the cooling passage body 121 is a sealing flange 126 which protrudes radially outwards beyond the tube section 127 and serves to seal an opening 101 of a through passage or a through opening, for example a drilled hole 198 in the workpiece 190. Preferably provided on the underside of the sealing flange 126 forming a sealing section 124 is a seal 145 which makes contact with an upper side 104 of the workpiece 190, hereby sealing the upper opening 101. The cooling passage body 121 thus forms an upper sealing element 146 which seals the opening 101.

A lower sealing element 147 is in principle identical in design to the upper sealing element 146. Accordingly there is provided a tube section 128 which encompasses an outflow coolant passage 140. The sealing flange 126 seals the lower opening 102 of the through opening 198. The lower sealing element 147 fits up against an underside 105 of the workpiece 190.

The two sealing elements 146 and 147 which in principle form cooling passage bodies are for example connected to a coolant reservoir in the form of the reservoir 34, for example via flexible lines similar to the lines 37, 43 (not shown).

So that the inflow coolant 32 reaches directly a relatively small, narrow splitting zone 100 of the workpiece 190 and does not for example cool the through opening 198 as a whole—which of course would also be possible—there are tube-like passage sections 150 in front of each of the two sealing elements 146 and 147 and penetrating into the through opening 198. Between the passage sections 150 inserted in the through opening 198 there remains an intermediate space 151, through which the coolant 32 is able to reach the inner periphery of the through opening 198, at the point where the fracture line 80 should later run.

The coolant 32 is as it were immediately sucked out again, since it flows namely into the opposite passage section 150 of the lower sealing element 147, from where it is led away from the splitting zone and the area of the workpiece 190 to be cooled. There is thus always a flow of fresh, suitably cooled coolant 32 which after heating and heat transfer from the workpiece 190 into the coolant 32, is removed from the splitting zone 100 as an outflow coolant 42.

From the drawing it may be clearly seen that the splitting zone 100 is narrow, so that a precise fracture line 80 may be generated, when for example the fracturing device 11 acts from the outside on the workpiece 190 (shown schematically).

Provided in the fracture-splitting apparatus 210 shown in FIG. 4 is a cooling passage body 221 which has a certain similarity to the cooling passage body 21. An inner tube 227 is as it were mounted concentrically in an outer tube 228. The two tubes 227 and 228 are open at the ends, so that through the outlet opening 231 and the peripheral wall 229 of the tube 228 surrounding it in annular form, an inlet opening 241 for the returning coolant 42 is formed.

The tubes 227, 228, therefore the cooling passage body 221, may for example be put on to a workpiece 290, for example a plate 291, at the end face or front, but with an end clearance 53, so that the coolant 32 flowing out of the outlet opening 231 may reach the workpiece surface 204 and thus the splitting zone 100 of the workpiece 290 directly. From there the coolant 42 is as it were sucked directly away or may flow away from the splitting zone 100, namely into the inlet opening 241 and through the outflow coolant passage 40 for example back into a reservoir, not illustrated, in the form of the reservoir 34.

Now it would be conceivable that, purely due to the relatively close arrangement of outlet opening and inlet opening, the coolant 32 cools only the locally limited area of the splitting zone 100 of the workpiece 290. It is however preferable to provide an assembly forming a sealing section 224, namely a sealing flange 226 provided on the outer periphery of the outer tube 228, namely its peripheral wall 229. Provided at an end face of the sealing flange 226 is a seal 245, fitted for example in a recess or slot 253.

At this point it should be noted that of course the cooling passage body 221 may have a ring or annular shape, likewise the sealing flange 226. This is not important, though, and other cross-section geometries may also be provided depending on the desired geometry of the splitting zone 100.

The sealing flange 226 and the tube 228, 227 mounted above bound a coolant chamber 103 above the workpiece 290 or on its surface, in which the coolant 32 is held, i.e. cannot escape into the atmosphere. This makes consumption of coolant very circumscribed and economical.

The cooling passage body 221 forms as it were an upper sealing element.

A fracture-splitting apparatus 310 according to FIGS. 5, 6 includes for example a cooling passage body 321, which is also designed for positioning on a workpiece surface, namely for example on the surface of a plate 391 representing a workpiece 390.

A cooling passage body 321 of a cooling unit 320 includes a passage element 323 which bounds a passage 322. The passage 322 runs for example beneath an upper wall 325 of the cooling passage body 321. Provided roughly transversely in the centre is a tube section 327, in which an inflow coolant passage 330 leads into the passage 322 forming as it were a transverse passage, so that the coolant 32 is able to flow from the tube section 327 through the passage 322 to the transverse ends or longitudinal ends of the cooling passage body 321, where it then flows back out of the cooling passage body 321 through outflow coolant passages 340 provided in the tube sections 328.

The cooling passage body 321 may for example be set on the top 304 of the plate 391. Then, a peripheral wall 329 protruding from a side wall 326 lies with its end face on the top 304 of the workpiece 390, thereby forming a sealing section 324. The walls 326, 329 bound the passage 322 at the top and the side.

Naturally it would be possible to provide on the sealing section 324 a rubber seal or other similar impermeable material as a seal assembly. At any rate the splitting zone 100 is as it were enclosed in a chamber 103 by the cooling passage body 321, so that coolant 32 or outflowing coolant 42 cannot escape to the atmosphere, resulting in economical consumption.

Naturally it is also possible for a further cooling passage body 321′ to be provided in a corresponding manner to an underside or opposite side of the workpiece 390, so that the workpiece 390 is as it were cooled locally from both sides, before a fracturing device 11 initiates the fracture-splitting process, e.g. from the top 304 of the workpiece 90.

A fracture-splitting apparatus 410 shown in FIGS. 7 and 8 has a cooling passage body 421 of a cooling unit 420 which has an insertion hole 455 for the insertion or passing through of a workpiece, for example a workpiece 490, comprising or formed by a rod 491.

The cooling passage body 421 is as it were in two parts, since it includes a first and a second sealing element 446 and 447, in each of which runs a cooling passage, namely an inflow coolant passage 430 and an outflow coolant passage 440. The sealing elements 446 and 447 may be moved towards and away from one another by drives 450, 451, as indicated by arrows 456.

The two sealing elements 446 and 447 which as it were bound the insertion hole 455 at the side (at top and bottom the insertion hole 455 is open, so that the workpiece 490 may in principle also be passed through or inserted into the insertion hole 455) are for example in the form of grippers or forks. At any rate the inflow coolant passage 430 opens out in the insertion hole 455 with an outlet opening 431, so that the coolant 32 can flow around the workpiece 490 from the outside or flow along its outer periphery, until as it were it flows as outflow coolant 42 into an inlet opening 441 of the outflow coolant passage 440.

The sealing elements 446 and 447 are fork-shaped. Between legs 457 of the sealing elements 446, 447 and the workpiece 490 and the rod 491 respectively, a flow channel 458 remains free; through this the coolant 32 is able to flow, and in so doing flood or flow around the workpiece 490.

Provided between the legs 457 is a tube section 227, 228 in which run the inflow coolant passage 430 and the outflow coolant passage 440.

In an advantageous measure it is provided that a seal 459 is provided at an upper and/or lower insertion area of the insertion hole 455, so that the coolant 32 flowing through the flow channel 458 is as it were enclosed, i.e. a chamber 103 is defined. The seals 459 are for example components of a seal assembly and/or define a sealing section 424 of the cooling unit 420.

If the two form-fitting bodies or sealing elements 446 and 447 are removed from one another (arrows 456) or the workpiece 490 is removed from the insertion hole 455, then for example the fracturing device 11 with its fracture-splitting workpieces 12 is able to act on the workpiece 490 from its outer periphery, fracturing it along a fracture line 80, plotted schematically by a straight line.

1. A fracture-splitting apparatus for the fracture-splitting of workpieces, in particular engine components or connecting rods, with a cooling unit for cooling the workpiece in a splitting zone and with a fracturing device for fracture-splitting of the workpiece in the area of the cooled splitting zone, wherein an inflow coolant passage opens out at one or more outlet openings of the cooling unit to cool the splitting zone, wherein the cooling unit has for locally limited cooling of the workpiece (90-490) in the splitting zone at least one sealing section for sealing contact with the workpiece adjacent to the splitting zone and/or to remove the coolant from the splitting zone of the workpiece at least one inlet opening of at least one outflow coolant passage arranged next to the outlet opening or openings of the inflow coolant passage.

2. The fracture-splitting apparatus according to claim 1, wherein a seal assembly is provided on the sealing section or sections.

3. The fracture-splitting apparatus according to claim 1, wherein the cooling unit is designed to apply the coolant under pressure to the splitting zone of the workpiece and/or to apply the coolant to the splitting zone in a liquid state.

4. The fracture-splitting apparatus according to claim 1, further comprising a regeneration unit for the regeneration or cooling of the coolant returning via the outflow coolant passage and for feeding to the inflow coolant passage the coolant thus cooled down, and/or that the outflow coolant passage and the inflow coolant passage form parts of a self-contained coolant circuit.

5. The fracture-splitting apparatus according to claim 1, wherein the cooling unit has a tubular body and/or a cooling passage body which may be inserted in an opening of the workpiece.

6. The fracture-splitting apparatus according to claim 5, wherein the outlet opening or openings and/or the inlet opening or openings are provided on a peripheral wall of the tubular body or the cooling passage body.

7. The fracture-splitting apparatus according to claim 5, wherein an outer periphery and/or an end face of the tubular body or the cooling passage body are provided with a seal assembly and/or form the sealing section or sections or a portion thereof.

8. The fracture-splitting apparatus according to claim 1, wherein a line with the inflow coolant passage is provided in an interior of a line with the outflow coolant passage.

9. The fracture-splitting apparatus according to claim 1, wherein the sealing section comprises a seal assembly, the seal assembly encompassing an operating area of the cooling unit at which the outlet opening or openings and/or the inlet opening or openings are located, wherein between the cooling unit and the workpiece, by means of the seal assembly, a sealed coolant chamber is formed, when the cooling unit is in contact with the workpiece.

10. The fracture-splitting apparatus according to claim 1, wherein the cooling unit has an insertion hole for insertion or pushing through of the workpiece, wherein the inflow coolant passage and/or the outflow coolant passage communicate with the insertion hole for introducing the coolant into the insertion hole or removing the coolant from the insertion hole.

11. The fracture-splitting apparatus according to claim 1, wherein at least one sealing device is provided for closing a drilled hole, of the workpiece adjacent to the splitting zone into which the cooling unit dips.

12. The fracture-splitting apparatus according to claim 11, wherein the sealing device includes a sealing element separate from the cooling unit.

13. The fracture-splitting apparatus according to claim 11, wherein the sealing device includes a first sealing element and a second sealing element for sealing a first opening and a second opening of a through passage of the workpiece.

14. The fracture-splitting apparatus according to claim 11, wherein the sealing device includes the outlet opening or openings and/or the inlet opening or openings.

15. The fracture-splitting apparatus according to claim 1, wherein the outlet opening or openings is or are located between at least two inlet openings and/or the inlet opening or openings extend in annular form around the outlet opening or openings.

16. The fracture-splitting apparatus according to claim 1, wherein the coolant comprises alcohol and/or nitrogen and/or dry ice.

17. A method for the fracture-splitting of workpieces, in particular engine components or connecting rods, with the steps:
cooling of a splitting zone of the workpiece by a cooling unit, comprising
application of the coolant to the splitting zone via an inflow coolant passage which opens out at one or more outlet openings of the cooling unit to cool the splitting zone
locally limited cooling of the workpiece in the splitting zone through sealing application of at least one sealing section of the cooling unit on the workpiece next to the splitting zone and/or removal of the coolant from the splitting zone of the workpiece via at least one outflow coolant passage, wherein the outflow coolant passage or passages has or have at least one inlet opening adjacent to the outlet opening or openings of the inflow coolant passage, and
fracture-splitting of the workpiece in the area of the cooled splitting zone.
